(19) United States
(12) Patent Application Publication
(10) Pub. No.: US 2013/0091130 A1
(43) Pub. Date: Apr. 11, 2013

(54) SYSTEMS AND METHODS THAT UTILIZE PREFERENCE SHIELDS AS DATA FILTERS

(71) Applicant: David Barrow, Devon (GB)

(72) Inventor: David Barrow, Devon (GB)

(21) Appl. No.: 13/649,049

(22) Filed: Oct. 10, 2012

Related U.S. Application Data
(60) Provisional application No. 61/546,008, filed on Oct. 11, 2011.

(51) Int. Cl. G06F 17/30

(52) U.S. Cl. 707/723; 707/E17.082

(57) ABSTRACT

Systems and methods that utilize preference shields as data filters are provided herein. Exemplary methods may include receiving a query from a first user, selecting a preference shield for the first user from a database that includes preference shields, applying the preference shield to query responses obtained for the query, and returning a response to the first user that includes filtered query responses that have been obtained by application of the preference shield to the query responses.

### CROSS-REFERENCE TO RELATED APPLICATIONS

This non-provisional patent application claims the priority benefit of provisional U.S. patent application Ser. No. 61/546,008, filed on Oct. 11, 2011, entitled “SYSTEMS AND METHODS THAT UTILIZE PREFERENCE SHIELDS AS DATA FILTERS,” which is hereby incorporated by reference in its entirety. This non-provisional patent application is also related to nonprovisional U.S. patent application Ser. No. 12/962,471, filed on Dec. 7, 2010, entitled “SYSTEMS AND METHODS THAT UTILIZE PREFERENCE SHIELDS AS DATA FILTERS,” and to provisional U.S. patent application Ser. No. 61/267,767, filed on Dec. 8, 2009, entitled “SEARCH ENGINE USING PREFERENCE SHIELDS AS DATA FILTERS,” and provisional U.S. patent application Ser. No. 61/673,158, filed on Jul. 18, 2012, entitled “VECTOR-BASED PREFERENCE MATCHING WITH ONTOLOGICAL DATA,” which are hereby incorporated by reference in their entirety.

### FIELD OF THE INVENTION

The present invention relates generally to systems and methods that utilize preference shields as data filters, and more specifically, but not by way of limitation, to systems and methods that utilize preference shields to filter search results, maintain adaptive inventories, provide targeted advertisements, and the like. Additionally, these systems and methods provide extensions for preference shields and portals for preference shield management.

SUMMARY OF THE TECHNOLOGY

According to some embodiments, the present technology may be directed to a method that includes the steps of: (a) executing instructions by a processor, the instructions stored in memory to: (i) receive a query from a first user; (ii) select a preference shield for the first user from a database that includes preference shields; (iii) apply the preference shield to query responses obtained for the query; and (iv) return a response to the first user that includes filtered query responses that have been obtained by application of the preference shield to the query responses.

According to some embodiments, the present technology may be directed to a system that includes: (a) a processor; and (b) logic encoded in one or more tangible media for execution by the processor and when executed operable to perform operations comprising: (i) receiving a query from a first user; (ii) selecting a preference shield for the first user from a database that includes preference shields; (iii) applying the preference shield to query responses obtained for the query; and (iv) returning a response to the first user that includes filtered query responses that have been obtained by application of the preference shield to the query responses.

According to some embodiments, the present technology may be directed to a method that comprises: (a) executing instructions by a processor, the instructions stored in memory to: (i) obtain a request to incorporate at least a portion of a preference shield of a first user into a preference shield of a second user; (ii) obtain the at least a portion of the preference shield of the first user from a database that includes preference shields; (iii) combine the at least a portion of the preference shield of the first user into the preference shield of the second user to create an extended preference shield for the second user; and (iv) store the extended preference shield in the database.

According to some embodiments, the present technology may be directed to a method that comprises: (a) executing instructions by a processor, the instructions stored in memory to: (i) evaluate a plurality of preference shields that correspond to customers of the merchant; (ii) compare the preferences included in the preference shields to inventory of the merchant; and (iii) generate the scorecard based upon the comparison.

According to some embodiments, the present technology may be directed to a method that comprises: (a) executing instructions by a processor, the instructions stored in memory to: (i) evaluate a plurality of preference shields that correspond to customers of the merchant; (ii) compare the preferences included in the preference shields to inventory of the merchant; and (iii) generate the scorecard based upon the comparison.

According to some embodiments, the present technology may be directed to a non-transitory machine-readable storage medium having embodied thereon a program. In some embodiments the program may be executed by a machine to perform a method. The method may comprise: (a) receiving a query from a first user; (b) selecting a preference shield for the first user from a database that includes preference shields; (c) applying the preference shield to query responses obtained for the query; and (d) returning a response to the first user that includes filtered query responses that have been obtained by application of the preference shield to the query responses.

### BRIEF DESCRIPTION OF THE DRAWINGS

Certain embodiments of the present technology are illustrated by the accompanying figures. It will be understood that the figures are not necessarily to scale and that details not necessary for an understanding of the technology or that render other details difficult to perceive may be omitted. It will be understood that the technology is not necessarily limited to the particular embodiments illustrated herein.

FIG. 1 is a block diagram of an exemplary architecture constructed in accordance with various embodiments of the present technology.

FIG. 2 is a block diagram of a filtering application constructed in accordance with various embodiments of the present technology.

FIG. 3 is a flow diagram of a method that utilizes preference shields to obtain personalized search results.

FIG. 4 illustrates exemplary views of both wireless and web-based applications practicing aspects of the present invention.

FIG. 5 illustrates additional exemplary views of both wireless and web-based applications practicing additional aspects of the present invention.

FIG. 6 illustrates an exemplary preference shield compliant aggregator portal.

FIG. 7 is a block diagram of an exemplary computing system for implementing embodiments of the present technology.

### DETAILED DESCRIPTION OF EXEMPLARY EMBODIMENTS

The rise of general-purpose search engines and applications utilizing search features have obscured the fact that unstructured, free-text searches for Internet content have numerous drawbacks relative to the level of specificity with which search results may be obtained. For example, users interested in museums in Paris, France having Rembrandt paintings may utilize a general-purpose search engine or other application to search for Internet content corresponding to a phrase such as “Rembrandt museum Paris.” A search query such as this may often return excessive volumes of links to websites associated with museums and the like, yet highly relevant results such as the Louvre (having a large collection of Rembrandt paintings) may be buried deeply within the search results, or may be completely omitted. These negative effects may be due, in part, to the relative ease with which search engine optimization techniques may be utilized by companies to artificially elevate irrelevant results within search results for their own benefit.

In contrast, the systems and methods disclosed herein may utilize preference shields as data filters to substantially ameliorate the aforementioned drawbacks and obtain and provide users with relevant and personalized search results. In some embodiments, the systems and methods may allow users to create preference shields that include information indicative of the preferences of the users. The preference shields may be applied to search queries received from a user to provide the user with only search results that are personalized relative to the preferences of the user. According to additional embodiments, some of the systems and methods may allow providers (e.g., merchants) to align their inventory and/or advertisements in accordance with the information included in the preference shields of customers.

Exemplary embodiments of the present invention include systems that may store user preferences in preference shields according to well-defined hierarchical structures, which may also be referred to herein as taxonomies. User preferences may be arranged as nodes in such taxonomies and may be entered into the system either directly through an application programming interface (A.P.I.), or through a space-time capsule, which is a specific set of software to connect to the systems of the present invention.

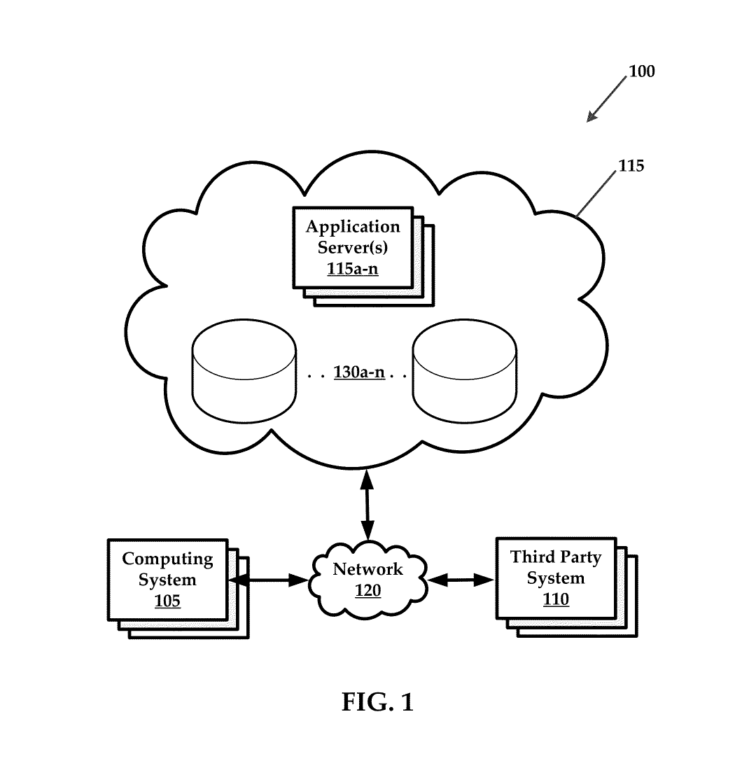

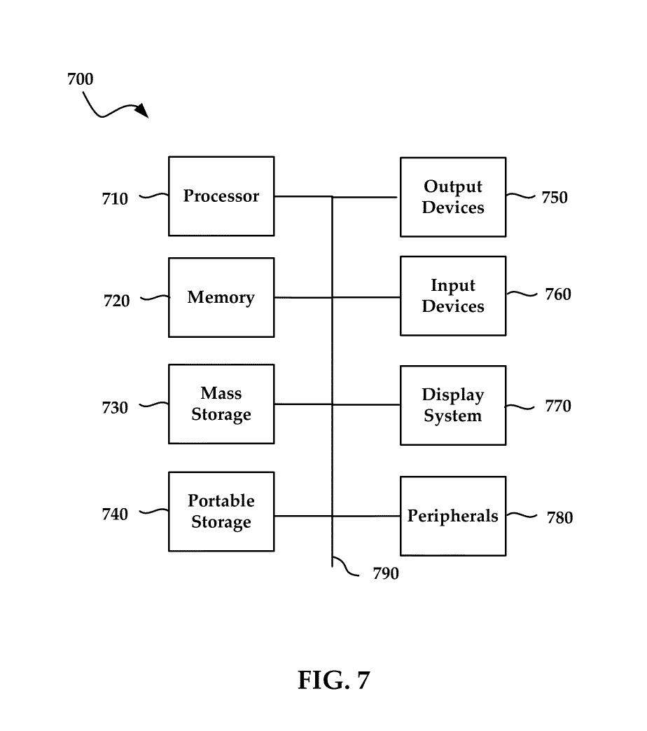

FIG. 1 is a block diagram of an exemplary architecture 100, constructed in accordance with various embodiments of the present technology. Any number of any of elements 105-115 may be present in the architecture 100. The architecture 100 may include a plurality of computing systems 105 such as end user computing systems. It will be understood that the computing systems 105 may include computing systems such as the exemplary computing system 700 described in greater detail with regards to FIG. 7. The computing systems 105 may be communicatively coupled with a plurality of third party merchant systems 110 via a filtering system 115 via a network 120 that may include the Internet, an Intranet network such as a L.A.N. (Local Area Network) or W.A.N. (Wide Area Network), a V.P.N. (Virtual Private Network)—just to name a few.

Generally speaking, third party merchant systems 110 may include computing systems such as a server having one or more merchant applications residing thereon. It will be understood that a merchant application may include any one of a number of applications having functionalities specific to the services or products of the merchant. For example, a merchant that offers seating accommodations for restaurants may provide users access to an application that allows users obtain and/or modify reservations for specific restaurants. Additional examples of provider systems include search engines, educational institutions, retail establishments, and the like.

In some embodiments, the filtering system 115 may be configured a cloud computing environment. In general, a cloud-based computing environment is a resource that typically combines the computational power of a large grouping of processors (such as within application servers 115a-n) and/or that combines the storage capacity of a large grouping of computer memories or storage devices (such as preference shield databases 130a-n). For example, systems that provide a cloud resource may be utilized exclusively by their owners, such as Google™ or Yahoo! ™; or such systems may be accessible to outside users who deploy applications within the computing infrastructure to obtain the benefit of large computational or storage resources.

The cloud may be formed, for example, by a network of web servers such as application servers 115a-n, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

Each of the application servers 115a-n may be described as a computing system adapted for the particular purposes of obtaining personalized search results for users by receiving search queries for Internet content from one or more computing systems 105. The application servers 115a-n may filter Internet content located in response to receiving the one or more search queries utilizing one or more preference shields to obtain one or more personalized search results. As such, the application servers 115a-n may be broadly described as a particular purpose computing system adapted to transform at least one of user preferences, user feedback, and/or responsive input into one or more preference shields that, in turn, transform search queries into at least one of: (i) search results that are personalized to the preferences of the user, (ii) empirical data for generating and delivering targeted advertisements, and/or (iii) empirical data that may be utilized by merchants to tailor their inventory based upon the actual behavior or preferences of their customers.

According to some embodiments, the application servers 115a-n may serve as a third party filtering system that maintains preference shields for users and processes search requests received from merchants on behalf of customers. In other embodiments, the application servers 115a-n may function as a particularized search engine that utilizes preference shields to process search requests directly from users.

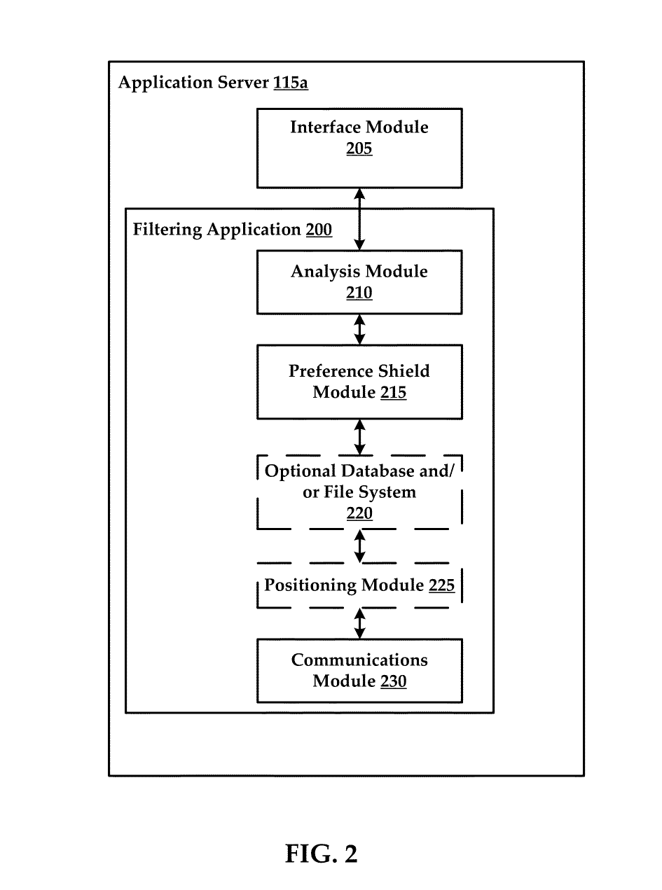

Referring now to FIG. 2, the application server 115a may include a filtering application 200. According to some embodiments, the filtering application 200 may include one or more modules or engines that are adapted to effectuate respective functionalities attributed thereto. It will be understood that the processor of the application servers 115a-n may execute one or more of the constituent modules described herein.

According to some embodiments, the filtering application 200 may include an interface module 205, an analysis module 210, a preference shield module 215, an optional database and/or file system module 220, and an optional positioning module 225. It is noteworthy that the filtering application 200 may include additional modules, engines, or components, and still fall within the scope of the present technology. As used herein, the term “module” may also refer to any of an application-specific integrated circuit (“ASIC”), an electronic circuit, a processor (shared, dedicated, or group) that executes one or more software or firmware programs, a combinational logic circuit, and/or other suitable components that provide the described functionality. In other embodiments, individual modules of the filtering application 200 may include separately configured web servers (e.g., application servers 115a-n).

Generally speaking, the interface module 205 may be configured to receive search queries via the network 120 from a computing system 105, such as an exemplary user digital device. According to various embodiments, search queries received via the interface module 205 may be stored for processing by the analysis module 210 at a later time. In some embodiments, the analysis module 210 may process the search query immediately. In some instances, search queries may be manually input by a user via a web browser application (not shown) or indirectly via a merchant application (e.g., an interactive location map, a G.P.S. application, etc.) operatively associated with or executable on the computing system 105. It will be understood that a merchant application may include any one of a number of third party applications capable of providing a user with search results in response to a request for Internet content.

According to other embodiments, search queries received from a merchant application may interface with the filtering application 200 via an application programming interface. Generally speaking, an application programming interface allows applications residing on different platforms or written in different coding languages to interoperate. As such, the particularities of the application programming interface utilized herein are dependent, in part, upon the particular language or languages with which the filtering application 200 and the provider application are coded. For the sake of brevity, as the filtering application 200 and the provider applications are not limited to any particular coding language, a detailed discussion of the use of application programming interfaces will not be provided as the creation and use of application programming interfaces would be well known to one of ordinary skill in the art with the present disclosure before them.

In various embodiments, the analysis module 210 may communicate with the interface module 205. For example, the interface module 205 may communicate a received search query to the analysis module 210. In some embodiments, a search query may be transmitted from the computing system 105 through the network 120 to the interface module 205 of the application servers 115a-n for delivery to the analysis module 210. The analysis module 210 may be adapted to locate Internet content corresponding to the search query, filtered according to one or more preference shields. According to other embodiments, rather than locating Internet content directly, the analysis module 210 may be adapted to receive a list of Internet content previously located by a merchant application. That is, the merchant application may perform an initial query response using, for example, one or more search engines. The initial search results may then be filtered according to the preferences of an end user by filtering the initial search results using one or more preference shields.

One skilled in the art will appreciate that the term “Internet content” comprises one or more web sites, domains, web pages, web addresses, one or more hyperlinks, URLs, any text, pictures, and/or media (such as video, audio, and any combination of audio and video) provided or displayed on a web page or other user interface, and any combination thereof. Furthermore, Internet content may include “attributes” that are indicative of the type of information contained within the Internet content. For example, attributes of Internet content may be extracted from associated metadata, tags, textual information present within the source code of a web page, and the like.

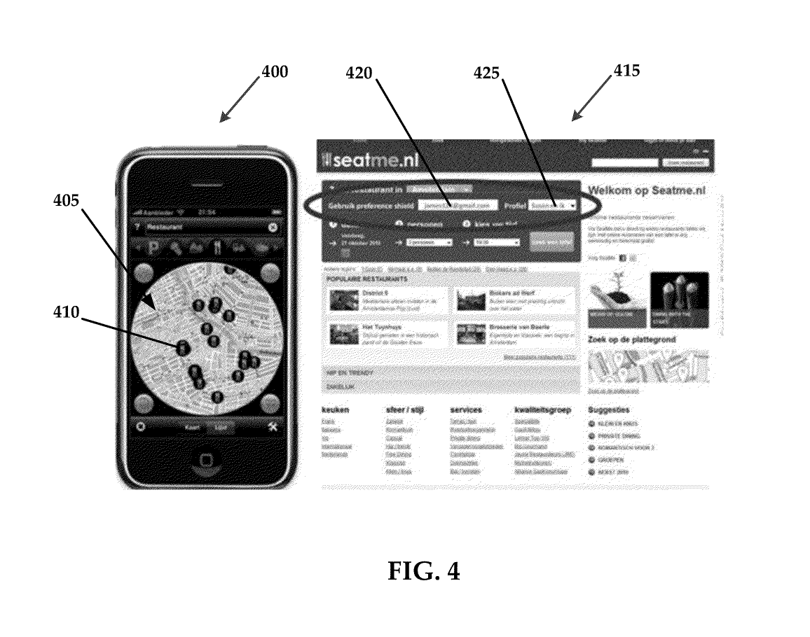

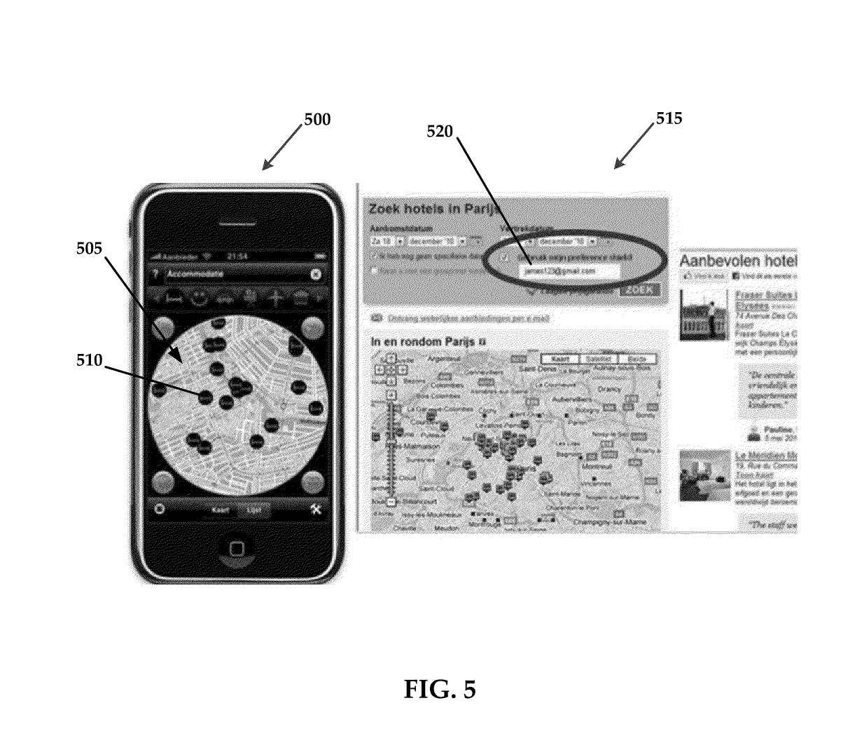

According to some embodiments, the interface module 205 may be adapted to generate one or more graphical user interfaces in the form of web pages (not shown) adapted to receive input in the form of user preferences. Additionally, the web pages may be adapted to receive input in the form of search queries. It will be understood that in some embodiments, such as when a merchant application interfaces with the filtering application 200, the merchant application may generate the necessary user interfaces. As such, the merchant application may direct search requests to the filtering application 200 and receive personalized search results in any acceptable format, which may be displayed to the user in a format chosen by the merchant. Exemplary views of personalized search results generated by the interface module 205 and a merchant application may appear as a result on computing system 105 (e.g., the map on a mobile device or in a web browser as shown in FIGS. 4 and 5).

The preference shield module 215 may communicate with the analysis module 210. Additionally, the preference shield module 215 may be operatively coupled with one or more of the interface module 205, the optional database and/or file system module 220 and the positioning module 225. Based upon user preference data received from the interface module 205, the preference shield module 215 may generate one or more preference shields for the analysis module 210 that may be utilized to obtain personalized search results in response to one or more search queries. As described earlier herein, the preference shield module 215 may organize user preferences according to a taxonomy that may include a plurality of primary nodes and sub-nodes indicative of user preferences. Additionally, as mentioned previously, the user preference data may be received by an end user who may, for example, answer a series, complete a survey, or complete any other information gathering task that is designed to elicit data that may explicitly or implicitly include user preference data. In some instances, user preference data may be obtained from user generated content such as web analytics.

The following are exemplary properties of some embodiments of preference shields. Some preference shields may automatically filter out any Internet content that does not include attributes corresponding to the user preferences of a particular user. For example, a preference shield may include user preferences such as Chinese restaurants within a certain price range. As such, the analysis module 210 may locate and/or evaluate Internet content according to the user preferences and obtain personalized search results including only restaurants serving Chinese cuisine within the specified price range (and/or perhaps within a particular geographic region, such as Boston).

Generally speaking, preference shields may be manually defined and fine-tuned over time, either manually or automatically. Some preference shields may be borrowed at least in part from another user or another entity. For example, at least a portion of a preference shield of a first user may be incorporated into the preference shield of a second end user. According to some embodiments, preference shields may be created by extracting user preferences from previous transactions conducted by the user. For example, a preference shield may be derived from what a user purchased at a department store or what a user bought using a credit card or another card that provides the user with the ability to track purchases.

Preference shields may also be based on direct responsive feedback. For example, the filtering application 200 may be adapted to receive feedback such as positive and negative feedback corresponding to search results provided to the user. Feedback may be utilized by the filtering application 200 to automatically update preference shields with refined user preferences such that the filtering application 200 may adapt and evolve over time.

As stated previously, the preference shield module 215 may organize user preferences within preference shields according to a hierarchical structure, such as ataxonomy, combining, at the highest level, primary nodes that contain broad topical identifiers such as dining, entertainment, fashion, etc. Each of the primary nodes may contain sub-nodes that further subdivide the primary node, similarly to a search tree structure. For example, a primary node of “Entertainment” at a first level may divide into a plurality of sub-nodes such as music, exhibitions, sports, etc. Likewise, second level sub-nodes located below the first level sub-nodes may include even more specific types of data. For example, a first level sub-node such as sports may subdivide into second level sub-nodes such as baseball, football, and basketball—just to name a few. Likewise, the second level sub-node of baseball may into third level sub-nodes such as MLB, AAA, AA, A, College, etc. It will be understood that preference shield taxonomies may be subdivided into as many levels as desired by the user.

Some preference shields may be a combination of one or more sub-nodes from different primary nodes. For example, a preference shield for fashion and entertainment may appear as: Fashion|Male clothing|Suits|Armani|+|Entertainment|Sports|Baseball AA. It will be understood that although a preference shield may include a list items of interest corresponding to user preferences, the preference shield may not specifically list the items themselves. Rather, the preference shield may be indicative of the conditions (e.g., attributes) that a certain item of interest would have to match to comply with the user preferences of a particular user or group of users.

It will be understood that because preference shield taxonomies may be organized using common types of primary nodes or sub-nodes, global taxonomies may be created and maintained via collaborative effort utilizing a preference shield taxonomy repository. As such, users may publish their preference shields, preference shield taxonomies, or even individual user preferences to an online community (e.g., social network) for collaborative input from other users.

By way of non-limiting examples, if a first user and a second user are friends and have shared at least a part of their user preferences, the first user may share his preferences in Indian cuisine with his friends. Additionally, the second user may add the user preferences of the first user to the preference shield of the second user. It will be understood that the user preference may be arranged according to the taxonomy of the preference shield such as the primary node of Restaurant. In other embodiments, the first user may access and utilize at least a portion of the preference shield of the second user to locate an appropriate gift for the second user.

As special cases of sharing and reusing at least parts of preference shields, the filtering application 200 may allow users to utilize the preference shields of various notable entities. For example, the filtering application 200 may allow users to utilize the preference shield of their favorite celebrity for entertainment purposes. For example, a user may choose to look at events occurring in New York through the eyes of Madonna, Larry King, Derek Jeter, or Gary Vaynerchuk (a wine guru). According to an additional example, the filtering application 200 may allow users to utilize the preference shield of an icon. Preference shields of icons function similarly to celebrity preference shields. For example, a user may choose to look at events occurring in New York through the eyes of Don Draper, James Bond, Walter Cronkite, or Frank Sinatra.

In an additional example, the filtering application 200 may utilize brand shields. For example, a user may choose to look at events occurring in New York through the eyes of popular magazines or public figures, such as Newsweek, Gentleman Quarterly, Oprah, or JFK.

It will be further understood that because the attributes of Internet content are dynamic and constantly changing, preference shields may be automatically and continuously updated to reflect these changes. For example, restaurants that only offer specific types of cuisine may expand over time to provide additional types of cuisine that may appeal to the user preferences of a particular user.

According to some embodiments, users may have multiple preference shields catering to different moods/modes (e.g., business travel) or different circumstances (e.g., “out with the family”). As such, the preference shield module 215 may be adapted to update the particular preference shield that is currently being utilized by the analysis module 210 based upon responsive input or feedback received from the user via the interface module 205.

The filtering application 200 may adaptively modify preference shields based upon positive and negative feedback received from users. Examples of adaptive modification may include the preference shield module 215 automatically modifying one or more preference shields of one or more users based on direct feedback such as feedback indicative of a positive or negative experience corresponding to a personalized search result.

For example, the user may receive a personalized search result from the filtering application 200 for “great tandoori chicken in the neighborhood” but is subsequently not impressed with the food. The user may then enter feedback into the filtering application 200 that may be adapted to inquire whether “it's that specific restaurant, the tandoori chicken, or Indian cuisine in general” that require an update in the preference shield of the user.

In some embodiments the preference shield module 215 may be adapted to aggregate or combine two or more preference shields of two or more users together to create a shared preference shield. Therefore, only search results that conform to the combined user preferences of all users as represented by the shared preference shield may be provided to the users.

According to some embodiments, the filtering application 200 may be adapted to allow the user to view inspect “near miss” search results excluded by the analysis module 210. Near misses may be broadly categorized as search results that may be excluded based on user preferences contained with one or more preference shields. It will be understood that if the analysis module 210 is utilizing a shared preference shield, “near misses” may include personalized search results that were not conveyed to one or more of the users because of the combined user preferences of the shared preference shield. In other words, the analysis module 210 determines that certain Internet content conformed to the preference shield of a first user, but such search results were suppressed in compliance with the preferences of the shared preference shield. Following an analysis of near misses, a user may decide to update his shield to allow some or all of the “near miss” search results to be included in future search results. It will be understood that the interface module 205 may be adapted to generate a display for communicating the “near miss” search results utilizing a separate reporting environment, such as an environment independent of the application itself (e.g., a web browser, log file, etc.).

In accordance with the present disclosure the filtering application 200 may be adapted to utilize priorities to further refine personalized search results. Generally speaking, the priorities encompass empirical user preferences based on the actions of the user in light of the conveyed information. For example, the priorities may reflect the reactive user input received in response to displaying personalized search results and other induced information. Priority data may be utilized in near-miss analyses as described above, and may be a basis for prioritization of personalized search results.

According to some embodiments, users may grant merchants or other providers access to their preference shields such that the merchant may generate targeted advertising or manage their inventory in response to the user preferences of their customers.

The filtering application 200 may also be adapted to allow merchants to see the likelihood that a particular customer will accept a particular offer in a particular category or subset. To these ends, the filtering application 200 may be configured to establish a propensity factor for customers based upon the purchase habits of the customer. The propensity factor may be indicative of the likelihood of a customer to respond to a particular advertisement or purchase a particular product. These methods may require that the merchant report offer and acceptance information back to the filtering application 200.

By way of non-limiting example, a business, such as a wine shop, might utilize a business-to-business functionality of the filtering application 200 to define or modify an inventory. The hypothetical wine shop might see user preferences across a sample of their customer that would define their inventory as follows: within the Red Wine category, 35 percent of users selected Chilean in their preference shield, within the Red Wine Chilean category, 80 percent selected Cabernet Sauvignon, 75 percent selected Merlot, 45 percent selected a blend, and 15 percent selected Carmenere as one of their preferred grapes.

A multivariate version of the above example might be presented to the hypothetical wine shop as a scorecard for inventory as follows: In the last month there were 1,105 instances where user preferences were a close match with the inventory of the shop, but the user was not notified. For example, 100 users searched for Petite Syrah wines that are not part of the inventory of the shop, 800 users passed the shop within driving distance but outside of their stated radar coverage, 200 users passed the shop within walking distance but outside of their stated radar coverage, and out of the 978 users that were notified of the shop, in terms of user preference/inventory overlap the shop ranked first in 209 instances, second in 368 instances, and the like. According to some embodiments scorecards may be created utilizing customer demographics. The scorecards may give the merchants insight into which customers may be interested in a particular product or service.

Users may control the demographic information that is provided to the filtering application 200. For instance, an age of a user may be input as a birth date, a current age in years, or a particular age range. The user may also choose to not disclose their age. The filtering application 200 may also assist the user in defining how much information needs to be disclosed to maintain a balance between privacy and the desire for accurate information. Moreover, the filtering application 200 may allow the user to specify loyalty connections with specified merchants, such as a connection with a local wine shop in order to receive special offers from the wine shop.

The filtering application 200 may allow users to convert their preference shield and/or demographic information into a “Preference Certificate.” The user may submit this certificate to a merchant or other provider, an opt-out clearing house, or other entity that may subsequently, through the filtering application 200, evaluate potential advertisements or offers against user preferences before they are provided to the user. Under the guidelines of the preference certificate program any merchant may officially seek to comply with privacy policies of the system according to user preference shields. For example, such merchants would not send mail to, call, or otherwise contact a user unless an offering of the company is compliant with the preference shield of that user. Additionally, using the certificate received from the user, a selected company may confirm preference compliance in real-time during an inbound contact (e.g., via the web, call center, interactive voice response, etc) or before starting an outbound marketing campaign (e.g., mail, email, texting, phone, ATM, etc). In some embodiments, participating merchants cannot inspect a user's preferences; the merchant may only compare the parameters of their offer to the preference certificate. It will be understood that the preference certificates may be centrally maintained in a remote repository (e.g., server) for “permission marketing” to merchants.

According to various exemplary embodiments, the optional database and/or file system module 220 may store preference shields, preference shield zones, and/or preference certificates on a computer readable storage medium having information or data stored thereon (e.g., text, audio, links, web page captures, metadata, video and/or any combinations thereof), such as the databases 130a-n (see FIG. 1). The optional database and/or file system module 220 may store one or more preference shields that are generated by the preference shield module 215 or may store preference certificates indicative of one or more preference shields and demographic information. Because the preference shields are located remotely from the merchant systems 110, merchants may utilize the preference shields to provide the users with personalized search results without the need to maintain extensive databases of customer records.

In some applications the filtering application 200 may utilize the location of the computing system 105 (see FIG. 1) from which a search query is received to further refine the search results. As such, a positioning module 225 associated with the filtering application may determine the location of the computing system 105. The positioning module 225 may be adapted to utilize one or more types of positioning technology to determine the location of a computing system 105 associated with the user such as a cellular telephone or wireless PDA. Non-limiting examples of positioning technology include GPS, infrared, WI-FI, geo-location, radio frequency identification, uni-lateration, tri-angulation, multi-lateration, radio-location, dead reckoning, ultrasound identification, Bluetooth, or combinations thereof. The location information obtained by the positioning module 225 may be utilized by the analysis module 210 to further refine the personalized search results. It will be understood that positioning data may be received from a third party application not associated within the application servers 115a-n and/or filtering application 200.

Once the filtering application 200 has filtered or otherwise refined search results indicative of Internet content that complies with the user preferences of the one or more preference shields, a communications module 230 may communicate the search results to the computing system in a format that may be perceivable by a user. Personalized search results may be communicated in a format that may be utilized by one or more applications resident on the computing system 105 to generate user interfaces that include information indicative of the personalized search results (see FIGS. 4 and 5).

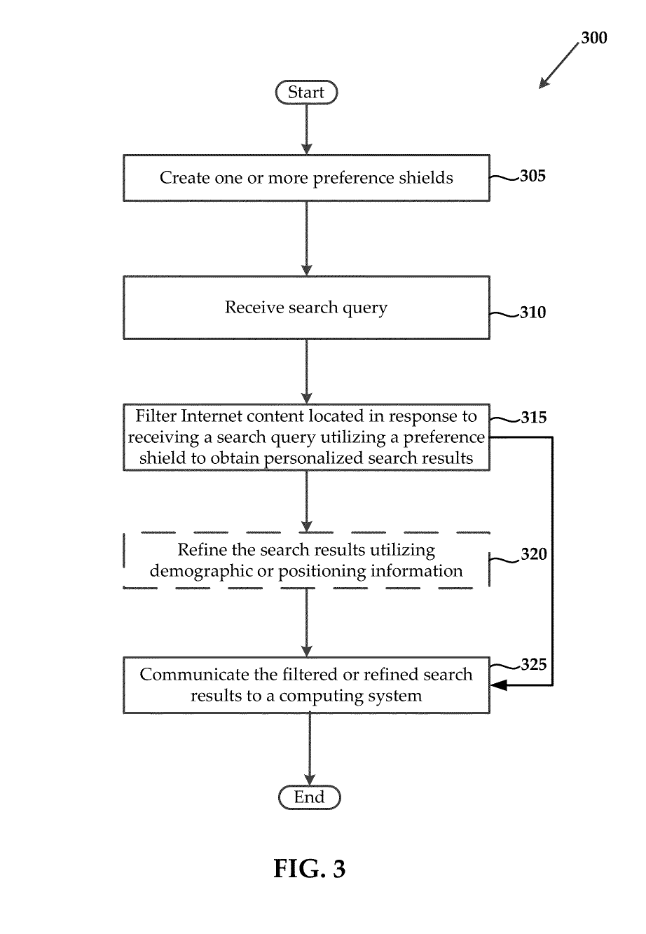

Referring now to FIG. 3, an exemplary method 300 that utilizes preference shields to obtain personalized search results may include a first step 305 of creating one or more preference shields by receiving user preferences via any one of a number of the aforementioned methods for determining user preferences, such as direct input from the user via a user interface.

After the user preferences have been received, the user preferences may then be organized or arranged into a hierarchical structure (e.g., taxonomy) having one or more primary nodes and sub-nodes indicative of user preferences.

Once the one or more preference shields have been established, the system may operatively associate the one or more preference shields with the user via, for example, a username and/or password. As such, merchant applications or third party search engines which are provided access to the preference shields of the user may utilize such preference shields in processing search queries received from users such that all or a portion of search queries received from the user are filtered via the one or more preference shields. For example, each merchant application may be adapted through an application programming interface, to direct all incoming search queries for a particular user through an application server having one or more preference shields resident thereon. The application server may filter search results such that only personalized search results that comply with the user preferences included in the one or more preference shields are provided to the users.

As such, the next step 310 in the method 300 may include receiving a search query. It will be understood that the search query may be received from manual input into a web browser or a merchant application executable on the computing system of the user.

The system then locates and filters Internet content corresponding to the received query via the one or more preference shields in step 315 to obtain personalized search results indicative of Internet content.

Additionally, in step 320 the system may also further refine the personalized search results via utilization of demographic or location specific data indicative of the location of the computing system.

The method 300 may also include the step 325 of communicating the filtered and/or refined search results to the user. For example, the search results may be communicated to a computing system in a format perceivable to the user such as a user interface in the form of a map having a plurality of icons indicative of personalized search results, which comply with the preference shield.

FIG. 4 illustrates exemplary views of both wireless and web-based applications for practicing aspects of the present invention. First, an exemplary wireless device 400 is shown as displaying personalized search results in the form of a user interface 405 such as a map that includes a plurality of search results in the form of icons 410. It will be understood that each of the icons 410 corresponds to a personalized search result indicative of a restaurant having available accommodations. Second, a web-based reservation application 415 (e.g., merchant application) is shown as including a text input box 420 adapted to receive user identification associated with one or more preference shields which are to be applied to the search queries received from the reservation application. A profile 425 may be obtained which may include one or more preference shields.

FIG. 5 illustrates exemplary views of both wireless and web-based applications for practicing aspects of the present invention. First, an exemplary wireless device 500 is shown as displaying personalized search results in the form of a user interface 505 such as a map that includes a plurality of search results in the form of icons 510. It will be understood that each of the icons 510 corresponds to a personalized search result indicative of a hotel having available accommodations. Second, a web-based hotel booking application 515 (e.g., merchant application) is shown as including a text input box 520 adapted to receive user identification associated with one or more preference shields.

According to some embodiments, the filtering application may allow for the use of both hard and soft preferences. The term “hard” preference may refer to a personal preference that the end user considers to be non-negotiable. That is, a hard preference is a requirement that preferably be reflected in the filtered search results. For example, an end user may specify that they are only interested in products that include one or more definable attributes. Likewise, the end user may define negative preferences that include dislikes. For example, common hard preferences relative to hotels may include price, location, and quality—just to name a few.

Soft preferences may be understood to include preferences that the end user considers to be negotiable. That is, soft preferences may or may not be utilized to filter out potential search results. It will be understood that search results that comply with hard preferences, but not necessarily soft preferences may be referred to as “near miss” search results.

Also, in some embodiments, near misses may include search results that correspond to only a subset of the hard preferences of the end user. That is, the system may consider some hard preferences as soft preferences if a search result complies with several (but not all) of the hard preferences of the end user.

The present technology may allow the end users to fine tune search results that correspond to their hard preferences but may or may not comport with their soft preferences. This type of configuration may be beneficial when a combination of both the hard and soft preferences of the end user cause the system to return a relatively few number of search results.

By way of non-limiting example, when searching for ski resorts, the preference shield of the end user may specify that the end user only prefers chalets that are very close to the ski slopes (e.g., less than 300 meters). However, if the system determines that relatively few search results correspond to the preferences of the end user, the system may determine that there are several chalets that correspond to other hard preferences of the end user. For example, the system may locate other chalets that correspond to price, quality, and so forth, but do not correspond to the hard preference of a distance from the ski slopes. Systems and methods described herein may return these results as near misses. In this example, the system may consider the distance from the ski slopes preference to be a soft preferences. Because it may be very important for the end user to obtain a chalet in a particular town, the system may provide the end user with near miss search results of chalets that are located at a distance greater than 300 meters from the ski slope. This allows the system to provide alternative search results rather than rejecting all search results because they do not comply with each and every hard preference of the end user.

To facilitate the use of soft preferences, the system may provide the end user with a user interface (not shown) such as a sliding scale or lever that allows the end user to adjust one or more of their preferences for the particular search. Returning to the example, the system may provide a lever that allows the end user to radially expand their acceptable “distance from the ski slopes” preference. Such enlargement of this distance value may locate chalets that are outside the 300 meter preference, but that correspond to many of the other hard preference of the end user.

In other embodiments, the systems and methods provided herein may allow end users to share preferences between one another via social media and social networking platforms. The systems and methods described herein may interface with these social media via an API and allow end users to share or post information regarding their preference shields. For example, the systems and methods described herein may allow end users to create social media messages that are indicative of their preference shield, such as “Joe Smith just extended Californian Wines in his preference shield. Share or merge?” Therefore, the systems and methods described herein may utilize these types of messages as viral marketing to encourage others to share or crosslink preference shields, or parts of preference shields. For example, if an end user is widely regarded as a wine aficionado, the end user may make their wine preferences available to the public for wider use via social media messaging.

It is noteworthy to mention that added or imported preferences that are selected from the preference shield of another user or generated by the systems and methods described herein (add-on or system generated preferences) may be referred to as preference shield extensions. That is, in addition to the end user created preference shield, the end user may extend their preference shield by adding on preferences from the preference shields of other end users, or preferences that are generated by the system. In this way, the preference shield of the end user may grow and evolve over time to further enhance the searching experience of the end user.

In other embodiments, the systems and methods described herein may provide end users with statistical information regarding the proliferation or use of their preference shield within the context of a social media platform. For example, “Your wine preferences are now used by 514 users, the following friends . . . , and have been used in recommendations over 100,000 times.”

Because of the ubiquity of social media, one of ordinary skill in the art will be familiar with the integration of such features with the systems and methods described herein. As such, a detailed discussion of such integrations will be omitted for the purposes of brevity.

The systems and methods described herein may also be configured to recommend preference shields or portions of preference shields to end users. Portions of preference shields may also be referred to as a “preference shield zone.” That is, a preference shield may be comprised of a plurality of preference shield zones. Exemplary preference shield zones may include food, lodging, and so forth. Preference shield zones may be further subdivided. For example, food may divide into more specific subcategories such as French, Indian, and so forth. Preference shield zones may be subdivided to any level of specificity desired.

In operation, if the systems or methods described herein determine that end users with similar preference shield configurations like a particular product, service, or preference shield extension, the systems and methods described herein may suggest certain preference shield extensions. An exemplary suggestive preference shield extension message may include, “15% of the users with similar preferences have done this. Import/merge?”

With further regard to accessing or executing embodiments of the systems and methods via mobile devices, end users may be allowed to utilize their preference shields in an on-demand manner. For example, within the context of an active search for a hotel, a particular hotelier may provide preference shield queries in cooperation with a preference shield service provider (e.g., an entity that manages preference shields on behalf of individuals), to the mobile device of the end user that may be utilized by the hotelier to fine-tune search results. The hotelier may query the preference shield on-the-fly by submitting the search query to the preference shield service provider, where the preference shield service provider applies one or more preference shields to the query to determine, for example floor height preferences (e.g., low, high, etc.). Such queries reduce the need for end users to pro-actively set numerous soft preferences that may only apply to the instant search. The end user may save these soft preferences in their preference shield.

Additional mobile features may include preference checks, via the preference shield service provider, where end users may verify that certain categories or preferences have been selected (or not selected). Other mobile features may include the limited exploration that further limits search results by restricting searches according to favorite zones (location based), last added (recent preferences), most applied preferences (commonly utilized preferences), and so forth.

According to some embodiments, merchants may not have access to the preference shields themselves. Therefore, “preferences checks” executed by a merchant may be performed by a preference shield service provider or administrator that operates the application servers 115a-n. Preference check results may be sent back to the merchant systems. The service provider may match offers to preference shields of the users and send anonymized, aggregated data to merchants looking for trends, inferences, and so forth.

The systems and methods described herein may allow end users to check and uncheck preferences to modify search results. For example, after performing a search for restaurants within a particular location, the end user may quickly select that sushi restaurants should be included in the search results, even though the preference shield of the end user normally restricts sushi restaurants from search results.

The systems and methods described herein may also allow for the use of fast feedback. This fast feedback may be shared via social media platforms, or may be stored in the preference shield of the end user for future references. For example, an end user may be dissatisfied with a particular restaurant that was suggested based upon the preferences of the end user. The system may show this feedback to the end user the next time the restaurant appears in a search result.

The systems and methods described herein may also allow for temporary adhoc shield sharing between two or more mobile devices. The sharing of shields may be utilized to create a temporary common denominator shield (shield having combined preferences of the end users). That is, the systems and methods may allow two mobile devices to combine and share preference shields utilizing any suitable handshake communication protocol between the mobile devices. In some embodiments, the handshake communications may be established between mobile devices through the system.

In other embodiments, handshake communications may be established between mobile devices via filtering applications on the mobile devices. That is, the filtering applications (mobile versions of the filtering application 200) may utilize communications protocols of the mobile devices (e.g., Bluetooth, infrared, direct link, etc.) to exchange preference shield data therebetween.

The systems and methods may also be configured to allow end users to maintain and utilize multiple preferences shields. These preferences shields may also include the combined preference shields of two or more individuals, as described above.

For example, an end user may maintain a personal preference shield, a business preference shield, and a family preference shield. By way of non-limiting example, a personal preference shield may differ from the business preference shield in that the business preference shield may include subsets of restaurants that are within a given price range that complies with the entertainment restrictions imposed by their employer. For example, if the end user is a salesperson, the business may define a preference shield for their salespeople that limit their salespeople from patronizing restaurants that the business considers to be unacceptably expensive.

A family preference shield may include the preferences of multiple people in a family. These preferences may be merged together from individual preference shields. It is readily apparent that preference shields for many different groups of individuals may likewise be created in accordance with the systems and methods. Therefore, one of ordinary skill in the art will appreciate that many permutations of the aforementioned examples may also be created in accordance with the present disclosure.

In some embodiments, the end user may utilize a main preference shield that may temporarily inherit the preferences of other preference shields (or end users) based upon a zone, time frame, and so forth. For example, a personal preference shield of an end user may inherit the preferences of the business preference shield during work hours.

Although not shown, the systems and methods described herein may generate various web-based portals that may be utilized to create, manage, and explore preference shields. According to some embodiments, the systems and methods may provide a consumer portal that allows end users to select, add, modify, inspect, and/or explore their preference shields. End users may select individual preferences via the consumer portal and view statistical data regarding a particular preference. For example, the portal may provide the end user with comparative data such as a percentage of additional end users with the same preference. Other data may include demographic data (e.g., the age or sex of other end users with the same preference). The portal may also provide “trending” or active preferences in an age category, or active preferences of end users proximate the consumer, or comparisons with other suggested preference shields (e.g., celebrity shields), and so forth. The consumer portal may also allow end users to inspect preference shield recommendations generated by the filtering application.

Consumers may create and sell preference shield zones, or entire preference shields via the consumer portal. It will be understood that because the preference systems and methods described herein may facilitate the monetization of preference shields (e.g., end user sales of preferences or preference shields), the systems and methods described herein may encode or provide a preference shield with digital rights management features or other security features that prevent unfettered transfers of preference shields without authorization. Advantageously, digital rights management features ensure that preference shield authors may restrict unauthorized dissemination or utilization of their preference shields.

Additionally, modifications to purchased preferences shields may be stored as layers to prevent end users from improperly re-selling modified preference shields. For example, the systems and methods provided herein may prevent consumers from importing a preference zone for fine jewelry, then subsequently adding a preference relative to sapphires, then selling it in the consumer portal without paying a reseller fee to the original author. As stated above, changes to an existing preference zone (or preference shield) may be stored as customization layers for the deltas in order for the digital rights of the preference shield to be protected.

The consumer portal may also provide visual depictions of preference shield statistics that include, but are not limited to, preference zones that are most hit or returned as search values (e.g., marketing radiation), preference zones that are the best/least defined, preferences zones that frequently shared (plus sharing stats), preference zones that are often imported, and preference shields that where recommendations are commonly available. Although not shown, these visual depictions may include graphs, diagrams, charts, and so forth.

In some embodiments, the customer portal may be directed to a particular type of end user. For example, the systems and methods described herein may manage and employ functionalities directed to celebrity end users. Exemplary embodiments may include tools that support celebrities/authorities and allow them to translate their knowledge into preference shields or particular preference zones.

Other embodiments may include the use of merchant portals that support features such as inventory optimization (e.g., where inventory may be selected based upon correspondence to the preference shields of customers, pricing may be adjusted based upon preferences, and so forth). Merchants may execute preference checks to aid in inventory optimization and generation of appropriate offers that are to be provided to customers. Again, preference check results may be sent back to the merchant systems. The service provider may match offers to preference shields of the users and send anonymized, aggregated data to merchants looking for trends, inferences, and so forth that may be utilized to predict inventory trends.

It will be understood that because the preference shields of the end user are located remotely from the merchant systems, merchants may substantially reduce their exposure to personally identifiable information of the customers. That is, preference shields may include only non-personally identifiable information and exclude information such as names, addresses, social security numbers, credit card numbers, telephone numbers, and so forth. As such, a merchant may target highly relevant advertisements to customers without the need to handle or access the personally identifiable information of the consumer. Moreover, because the preference shield service provider maintains and analyzes the preference shields of customers on behalf of the merchants, merchants receive trend data or other demographic information without needing to directly access the preference shields of their customers. Advantageously, such reductions in the exposure of merchants to personally identifiable information may reduce the merchant's liability for inadvertently exposing such information during a data breech.

Merchants systems (such as third party merchant systems 110 of FIG. 1) may utilize an interface that communicates with the filtering application to execute a variety of merchant related functions. Each of the functions may be associated with a particular API call between the third party merchant systems 110 and the filtering system 115 described above. Some functions may include a quick preference check of an offer to determine if the offer comports with the preference shield of the end user. These quick preference checks may be performed synchronously, or asynchronously in batch form. Other functions may include determining one or more current offers that an end user with which the end user would be interested. Merchants may also determine the propensity for an offer to be accepted by their customers in order to aid the merchant in creating offers that are likely to be accepted (create positive sales experiences) for their customers.

Additionally, the systems and methods provided herein may manage revenue streams generated from the sale of preference zones or entire preference shields. That is, the operator of the present systems may generate commissions from the sales of preference shields to end users on behalf of preference shield sellers.

The systems and methods provided herein may also generate reports for any one of the aforementioned merchant related functions.

Additionally, the system may provide support for category (preference zone) mapping that allows merchants to use real-time translation from their own product catalogues or current inventory.

Additionally, the present technology may support preference inferencing for merchants. That is, merchants may utilize systems and methods described herein to generate preference shield zones for their customers. These generated zones may be created from past transaction data or loyalty program information. Additionally, merchants may collaborate with other merchants who may market to similar customers (as determined by preference shield data) to optimize their catalogues against a larger “virtualized” customer base. Again, merchants may not have direct access to preference shields, but only demographic, trend, or inference information that corresponds to the preferences of their customers. Exemplary algorithms and methods for determining preference predictions and calculating inference data for inferring preferences may be found in co-pending provisional U.S. Patent Application Serial No. X, filed on X, entitled “VECTOR-BASED PREFERENCE MATCHING WITH ONTOLOGICAL DATA.”

With regard to merchant access to preference shield information, the present disclosure may allow end users to suppress certain types of information presented to merchants. For example, after the purchase of a relatively expensive product, the end user may specify that they are not interested in receiving advertisements for expensive products for a predetermined period of time. In another example, if an end user has eaten at a particular restaurant that serves French food, the end user may turn off or suppress advertisements for restaurants that serve French food for a predetermined period of time.

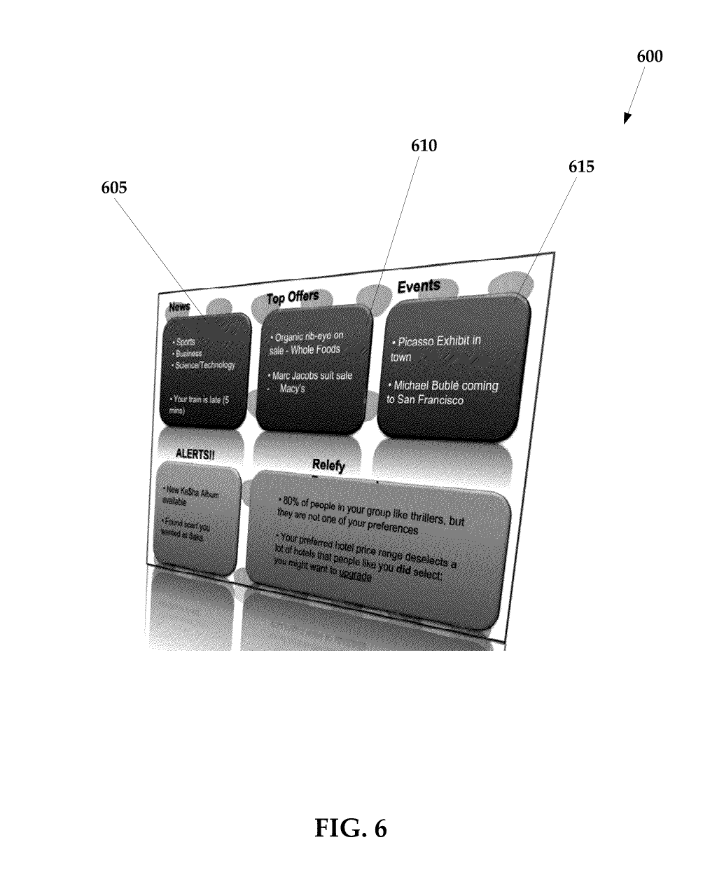

Additional embodiments of portals may include preference shield compliant aggregator portals that allow categories of merchants to market directly to customers. It is noteworthy that not all categories may be associated with a merchant. That is, some categories may correspond to informational data such as weather, news, and so forth. FIG. 6 illustrates an exemplary preference shield compliant aggregator portal 600 that includes a plurality of individual categories such as News 605, Top Offers 610, and Events 615. News 605 category may include preferred articles topics selected from preferred newspapers. Top Offers 610 category may include offers from merchants that correspond to the preference shield of the customer. It is noteworthy to mention that the ranking and/or placement of the individual offers may depend upon cost. That is, a merchant may pay the operator of the filtering system a greater amount for a higher placed offer, than a lower or less prominently displayed offer.

One of ordinary skill in the art will appreciate that many additional types of categories and/or arrangements of categories within the preference shield compliant aggregator portal may likewise be utilized in accordance with the present disclosure.

FIG. 7 illustrates an exemplary computing system 700 that may be used to implement an embodiment of the present systems and methods. The system 700 of FIG. 7 may be implemented in the contexts of the likes of computing systems, networks, servers, or combinations thereof. The computing system 700 of FIG. 7 includes one or more processors 710 and main memory 720. Main memory 720 stores, in part, instructions and data for execution by processor 710. Main memory 720 may store the executable code when in operation. The system 700 of FIG. 7 further includes a mass storage device 730, portable storage medium drive(s) 740, output devices 750, user input devices 760, a display system 770, and peripheral devices 780.

The components shown in FIG. 7 are depicted as being connected via a single bus 790. The components may be connected through one or more data transport means. Processor unit 710 and main memory 720 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 may store the system software for implementing embodiments of the present invention for purposes of loading that software into main memory 720.

Portable storage device 740 operates in conjunction with a portable non-volatile storage medium, such as a floppy disk, compact disk, digital video disc, or USB storage device, to input and output data and code to and from the computing system 700 of FIG. 7. The system software for implementing embodiments of the present invention may be stored on such a portable medium and input to the computing system 700 via the portable storage device 740.

Input devices 760 provide a portion of a user interface. Input devices 760 may include an alphanumeric keypad, such as a keyboard, for inputting alpha-numeric and other information, or a pointing device, such as a mouse, a trackball, stylus, or cursor direction keys. Additionally, the system 700 as shown in FIG. 7 includes output devices 750. Suitable output devices include speakers, printers, network interfaces, and monitors.

Display system 770 may include a liquid crystal display (LCD) or other suitable display device. Display system 770 receives textual and graphical information, and processes the information for output to the display device.

Peripherals 780 may include any type of computer support device to add additional functionality to the computing system. Peripheral device(s) 780 may include a modem or a router.

The components provided in the computing system 700 of FIG. 7 are those typically found in computing systems that may be suitable for use with embodiments of the present invention and are intended to represent a broad category of such computer components that are well known in the art. Thus, the computing system 700 of FIG. 7 may be a personal computer, hand held computing system, telephone, mobile computing system, workstation, server, minicomputer, mainframe computer, or any other computing system. The computer may also include different bus configurations, networked platforms, multi-processor platforms, etc. Various operating systems may be used including Unix, Linux, Windows, Macintosh OS, Palm OS, Android, iPhone OS and other suitable operating systems.

It is noteworthy that any hardware platform suitable for performing the processing described herein is suitable for use with the systems and methods provided herein. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a CD-ROM disk, digital video disk (DVD), any other optical storage medium, RAM, PROM, EPROM, a FLASHEPROM, any other memory chip or cartridge.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. Exemplary embodiments were chosen and described in order to best explain the principles of the present technology and its practical application, and to enable others of ordinary skill in the art to understand the invention for various embodiments with various modifications as are suited to the particular use contemplated.

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While various embodiments have been described above, it should be understood that they have been presented by way of example only, and not limitation. The descriptions are not intended to limit the scope of the technology to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the technology as defined by the appended claims and otherwise appreciated by one of ordinary skill in the art. The scope of the technology should, therefore, be determined not with reference to the above description, but instead should be determined with reference to the appended claims along with their full scope of equivalents.

What is claimed is:

1. A method, comprising:
executing instructions stored in memory by a processor to:
receive a query from a first user;
select a preference shield for the first user from a database that includes preference shields;
apply the preference shield to query responses obtained for the query; and
return a response to the first user that includes filtered query responses that have been obtained by application of the preference shield to the query responses.

2. The method according to claim 1, wherein the preference shield selected for the first user includes an ad hoc preference shield that includes a combination of at least a portion of preference shields of a plurality of end users, the first user being one of the plurality of end users.

3. The method according to claim 1, wherein the preference shield selected for the first user includes a preference shield for a second user.

4. The method according to claim 1, further comprising:
locate two or more preference shields for a first client device associated with the first user;
select one of the two or more preference shields based upon a current status of the first client device;
apply the two or more preference shields to search results obtained from a search query received from the first client device; and
transmit, to the first client device, filtered search results that comply with the preference shield.

5. The method according to claim 1, wherein the selected preference shield comprises hard preferences and soft preferences.

6. The method according to claim 5, wherein the filtered query responses include responses that comply with the hard preferences of the first user.

7. The method according to claim 6, wherein the filtered query responses include near miss responses, the near miss responses comprising responses that comply with at least a portion of the hard preferences of the first user and at least a portion of the soft preferences of the first user.

8. A method for generating an extended preference shield, the method comprising:
executing instructions stored in memory by a processor to:
obtain a request to incorporate at least a portion of a preference shield of a first user into a preference shield of a second user;
obtain the at least a portion of the preference shield of the first user from a database that includes preference shields;
combine the at least a portion of the preference shield of the first user into the preference shield of the second user to create an extended preference shield for the second user; and
store the extended preference shield in the database.

9. The method according to claim 8, further comprising suggest a preference shield zone for incorporation into a preference shield by:
comparing user preference data included in the preference shield to user preference data included in preference shields included in the database; and
selecting one or more preference shields based upon the comparison.

10. The method according to claim 8, wherein the preference shield selected for the first user includes a preference shield associated with an icon.

11. The method according to claim 8, wherein the extended preference shield is stored as a preference certificate, the preference certificate not including personally identifiable information.

12. The method according to claim 8, wherein the at least a portion of the preference shield of the first user includes preference shield zones.

13. A method, comprising:
executing instructions stored in memory by a processor to:
evaluate a plurality of preference shields that correspond to customers of a merchant;
compare the preferences included in the preference shields to inventory of the merchant; and
generate a scorecard of inventory based upon the comparison.

14. The method according to claim 13, further comprising:
select an advertisement for a customer based upon the scorecard of inventory and the preference shield of the customer; and
provide the advertisement to the consumer.

15. A system, comprising:
a processor; and
logic encoded in one or more tangible media for execution by the processor and when executed operable to perform operations comprising:
receiving a query from a first user;
selecting a preference shield for the first user from a database that includes preference shields;
applying the preference shield to query responses obtained for the query; and
returning a response to the first user that includes filtered query responses that have been obtained by application of the preference shield to the query responses.

16. The system according to claim 15, wherein the preference shield selected for the first user includes an ad hoc preference shield that includes a combination of at least a portion of preference shields of a plurality of end users, the first user being one of the plurality of end users.

17. The system according to claim 15, wherein the preference shield selected for the first user includes a preference shield for a second user.

18. The system according to claim 15, wherein the processor further executes the logic to perform operations of:
locating two or more preference shields for a first client device associated with the first user;
selecting one of the two or more preference shields based upon a current status of the first client device;
applying the two or more preference shields to search results obtained from a search query received from the first client device; and
transmitting, to the first client device, filtered search results that comply with the preference shield.

19. The system according to claim 15, wherein the selected preference shield comprises hard preferences and soft preferences and the filtered query responses near miss responses, the near miss responses comprising responses that comply with at least a portion of the hard preferences of the first user and at least a portion of the soft preferences of the first user.
